(19) United States
(12) Patent Application Publication
(10) Pub. No.: US 2004/0206250 A1
(43) Pub. Date: Oct. 21, 2004

(54) Device and method for manufacturing molded ice block

(76) Inventors: Nobuaki Kondou, Chiba (JP); Nobukazu Kondou, Chiba (JP)

Correspondence Address: GREENBLUM & BERNSTEIN, P.L.C., 1950 ROLAND CLARKE PLACE, RESTON, VA, 20191, US

(21) Appl. No.: 10/487,067

(22) PCT Filed: Oct. 16, 2002
(86) PCT No.: PCT/JP02/10717

(30) Foreign Application Priority Data
Oct. 17, 2001 (JP) 2001-319134

(51) Int. Cl. A47J 43/18

(52) U.S. Cl. 99/426

(57) ABSTRACT

The ice cake maker includes a pair of molds (A and B) formed from a material having a relatively high heat conductivity such as aluminum and guide rods (10) to guide the pair of molds (A and B) being moved in a predetermined direction. The molds (A and B) have molding concavities (7 and 8) at the sides thereof opposite to each other. A blank ice lump is melted at a part thereof being in contact with the molds (A and B) owing to a temperature difference between itself and molds (A and B), and molded into an ice cake having a predetermined shape defined by the molding concavities (7 and 8). Any unexperienced one can use the ice cake maker to make the ice cake having the predetermined shape easily and rapidly from the ice lump or broken ice pieces. Since no heaters are required, the apparatus can be operated with an improved safety. The apparatus is simply constructed, suitable for use to mass production of such ice cakes, and inexpensive. Thus, the ice cakes or balls can be made economically.

### FIELD OF THE INVENTION

The present invention relates to an ice cake making apparatus and method, for use in a bar, snack bar, pub, restaurant and ice works, for example, to mold an ice ball or cake having a predetermined shape from broken ice pieces or an ice lump as a blank easily, rapidly and safely.

### BACKGROUND ART

Conventionally, relatively large ball-shaped ice cakes are used for “on the rocks”, for example, served in a bar or the like. Such ball-shaped ice cakes are hand-shaped by a bartender of the bar. Therefore, whether the ice cakes can be given a desired shape depends greatly upon the bartender's skill.

As another solution to this ice ball making, an ice cake made by under-pressure hot melting to have a ball shape and an ice ball making method are known from the disclosure in the Japanese Published Unexamined Application No. 310277 of 1989.

The above ice cake making method uses a pair of pressing/heating molds which are vertically openable and closable. Each of the molds has formed in the pressing/heating surface thereof a hemispherical concavity shaped correspondingly to a half of an intended ice cake. A polyogonal ice lump or ice cube is placed as a blank between the concavities in the upper and lower pressing/heating molds being heated, and the molds are pressed from above and below, respectively, toward each other. Thus a ball-shaped ice cake is made by the under-pressure melting.

In the former one of the above ice ball making techniques, however, to shave a blank ice lump into a well-shaped ice ball, the bartender has to be well experience and skilled. It is difficult to form such an ice ball in a short time.

Also, heating of an ice lump or cube by the pressing/heating molds in the latter case takes longer than expected because the molds have to be heated amply by heaters, respectively. Further, this technique is not advantageous in that it needs the heaters and much water resulted from the ice cube or lump will adversely affect the heaters.

Furthermore, the pressing/heating molds can only provide a ball-shaped (or one type of) ice cake of which the shape will not thus be interesting.

### DISCLOSURE OF THE INVENTION

Accordingly, the Inventors of the present invention have devoted themselves to overcoming of the above-mentioned drawbacks of the related art, and found a method permitting any unexperienced and unskilled one to form an ice cake having a desired shape from broken ice pieces or ice lump easily, rapidly, safely and without using the heaters as in the conventional ice ball makers. Also, the Inventors have invented an ice ball maker simply constructed and which is thus suitable for mass production. The ice ball maker can provide ice balls or cakes inexpensively, and the ice cakes can be formed to have various interesting shapes.

(1) The above object can be attained by providing an ice cake maker including, according to the present invention, a pair of molds formed from a material having a relatively high heat conductivity such as aluminum, and guide rods which guide the pair of molds being moved relatively in a predetermined direction, the molds in pair having molding concavities formed at the sides thereof opposite to each other, and a blank ice lump in contact with the molding concavities in the molds in pair being partially melted owing to a temperature difference between itself and molds to form an ice cake having a shape defined by the concavities in the pair of molds.

With the ice cake maker constructed as above, an ice cake having a desired shape can be made easily and rapidly from a blank ice lump or broken ice pieces. The ice cake maker is easy to operate, and any unexperienced one can use the ice cake maker to easily form ice cakes having a desired shape.

Further, since the above ice cake maker according to the present invention needs no heaters as included in the conventional ice ball makers, it is safe to handle. Also, it is simply constructed and thus suitable for mass production. Therefore, it can provide the ice cakes inexpensively.

In the above ice cake maker, each of the molds is composed of a body having at least a receiving concavity formed therein and a molding block formed for replaceable installation in the receiving concavity. The molding block should preferably have at least a molding concavity formed therein.

In the above ice cake maker according to the present invention, a plurality of molding concavities of a shape or of different shapes may be formed in the molding block to form a plurality of ice cakes of the form or different shapes. This ice cake maker can provide ice cakes having various shapes and be used economically.

Also, in the ice cake maker, each of the molds should preferably have formed therein an appropriate channel through which cold or hot water can be passed.

By passing cold or hot water through the channel, the chilled molds can easily be restored to water temperature (normal temperature) or to a predetermined temperature, so that ice cakes can successively be molded to a predetermined shape with an improved efficiency.

More specifically, since tap water or the like can be used, it is possible to easily control the mold temperature and design the water channel to be relatively simple. In addition, the molds can be handled more safely because the ice cake maker needs no heaters. Further, hot water can be supplied directly or indirectly to the water channel from a water heater, which makes it possible to restore the chilled molds to a predetermined temperature easily and rapidly.

Moreover, one of the molds should preferably be provided with an appropriate removing means to take out a molded ice cake from the molding concavity. The removing means permits to remove the molded ice case from inside the molding concavity easily without any impairment to the ice cake.

(2) Also, the above object can be attained by providing an ice cake making method including, according to the present invention, the steps of disposing, in a lower position, one of a pair of molds formed from a material having a relatively high heat conductivity such as aluminum; placing a blank ice lump having a predetermined size over a molding concavity formed in the one mold; lowering the other mold having a molding concavity formed therein along guide rods and toward the one mold in the lower position until the blank ice lump is held tight in contact with the walls of the molding concavities in the molds in pair; and gradually melting the blank ice lump at its part being in contact with the molds owing to a temperature difference between the blank ice lump and molds until the blank ice lump is formed to have a shape defined by the pair of molding concavities, to thereby make an ice cake having a predetermined shape.

By the above method according to the present invention, an ice cake having a desired shape can be made easily and rapidly from a blank ice lump or broken ice pieces. The ice cake making is easy, and any unexperienced one can easily form ice cakes having a desired shape by the ice making method. Further, the method needs any heaters as in the conventional ice cake maker, which improves the safety in ice cake making.

In the ice cake making method, passing cold or hot water inside or outside the molds in pair permits to maintain a temperature difference between the blank ice lump and molds.

In the above method, passing cold or hot water inside or outside the molds permits to easily restore the chilled molds to water temperature (normal temperature) or to a predetermined temperature, so that ice cakes can successively be molded to a predetermined shape with an improved efficiency. More specifically, tap water or hot water from a water heater can be used to easily restore the mold temperature to the desired temperature.

These objects and other objects, features, and advantages of the present invention will become more apparent from the following detailed description of the preferred embodiments of the present invention when taken in conjunction with the accompanying drawings. It should be noted that the present invention is not limited to the embodiments but can freely be modified without departing from the scope and spirit thereof defined in the claims given later.

### BRIEF DESCRIPTION OF THE DRAWINGS

FIG. 1 is an exploded perspective view of a first embodiment of the ice cake maker according to the present invention;

FIG. 2 is an axial sectional view of the ice cake maker in FIG. 1, taking a pre-molding position;

FIG. 3 is an axial sectional view of the ice cake maker in FIG. 1, taking a post-molding position;

FIG. 4 is an exploded perspective view of a second embodiment of the ice cake maker according to the present invention;

FIG. 5 is an axial sectional view of the ice cake maker in FIG. 4, taking a pre-molding position;

FIG. 6 is an axial sectional view of the ice cake maker in FIG. 4, taking a post-molding position;

FIG. 7 is an exploded perspective view of a third embodiment of the ice cake maker according to the present invention;

FIG. 8 is an exploded perspective view of a fourth embodiment of the ice cake maker according to the present invention; and

FIG. 9 is an exploded perspective view of a fifth embodiment of the ice cake maker according to the present invention.

### BEST MODE FOR CARRYING OUT THE INVENTION

The present invention will be described in detail below concerning the embodiments thereof with reference to the accompanying drawings.

The ice cake maker according to the present invention is designed for anyone to easily mold clear ice cakes having a desired shape from a blank ice lump or broken ice pieces. As previously mentioned, it is suitable for use in a bar, snack bar, pub, restaurant and ice works, for example.

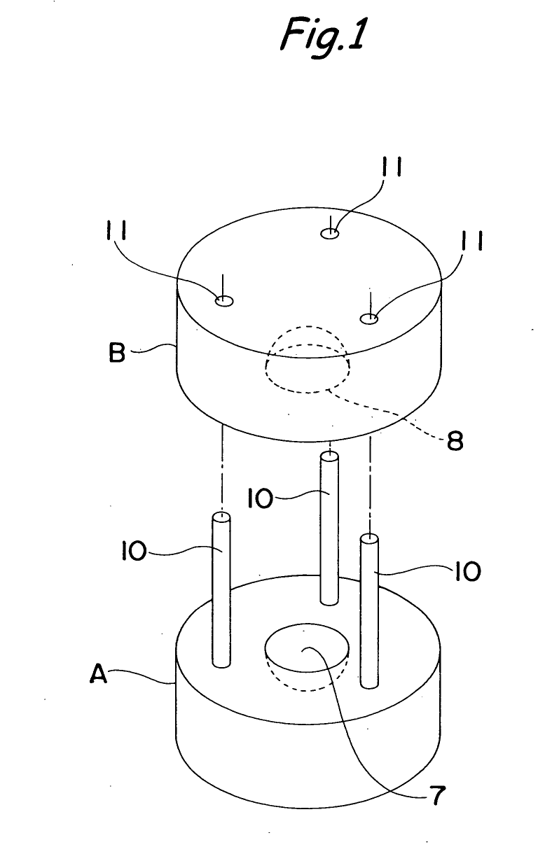

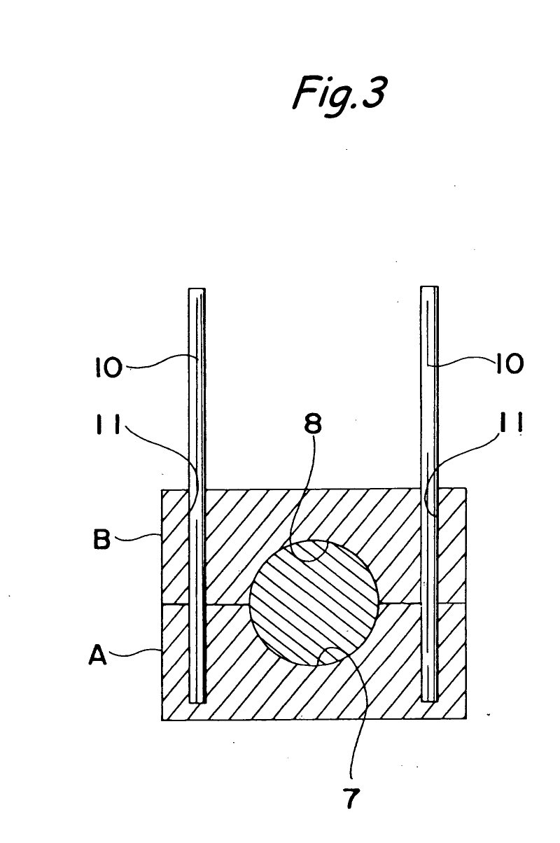

Referring now to FIGS. 1 to 3, there is schematically illustrated the first embodiment of the ice cake maker according to the present invention. As shown, the ice cake maker includes a pair of molds A and B disposed opposite to each other, and three guide rods 10 which guide the pair of molds A and B being moved vertically. The molds A and B have molding concavities 7 and 8, respectively, formed at the sides thereof opposite to each other.

More particularly, the molds A and B in pair are formed as cylinders nearly equal in size to each other. One (A) of the molds A and B is a stationary member on which the three guide rods 10 are provided extending vertically, while the mold (B) is disposed to be movable vertically in relation to the mold A along the guide rods 10 inserted in bores 12 formed in the mold A. The guide rods 10 are also penetrated through through-holes 11 formed in the mold B. The molds A and B have molding concavities 7 and 8, respectively, formed at the sides thereof opposite to each other. For making an ice cake, a blank ice lump is placed over the molding concavity 7 in the mold A. The upper mold B is lowered onto the ice lump. The weight of the mold B puts the ice lump into contact with the molding concavities in the molds A and B. The ice lump is melted owing to a temperature difference between itself and molds, and formed into a shape defined by the molding concavities 7 and 8.

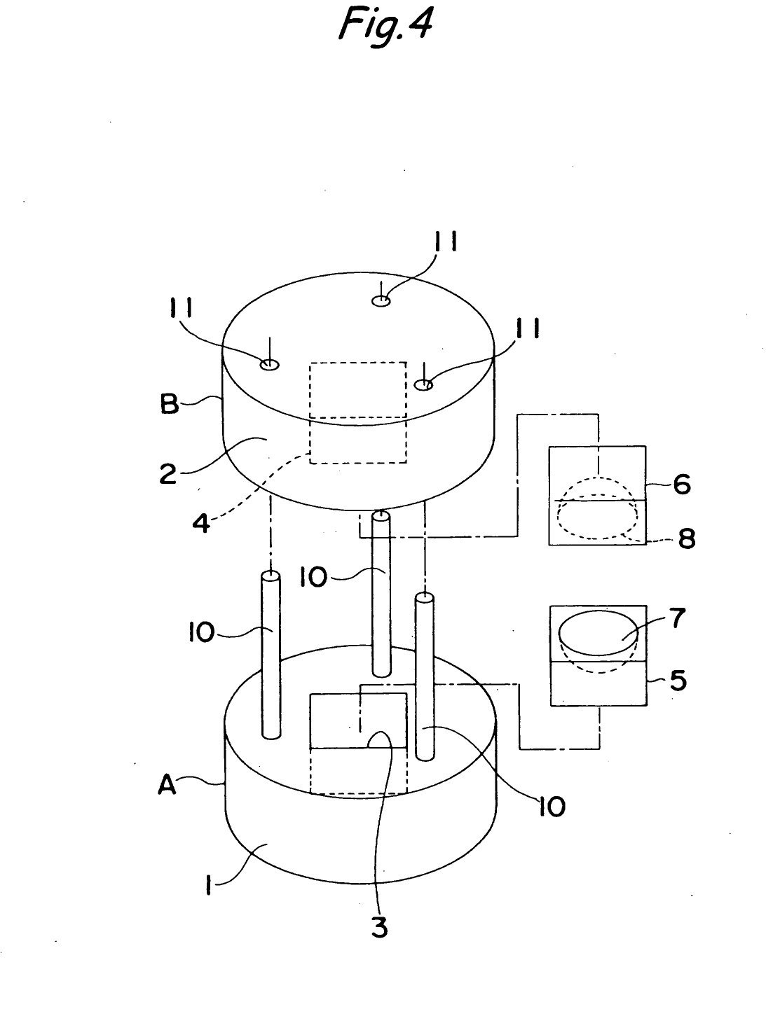

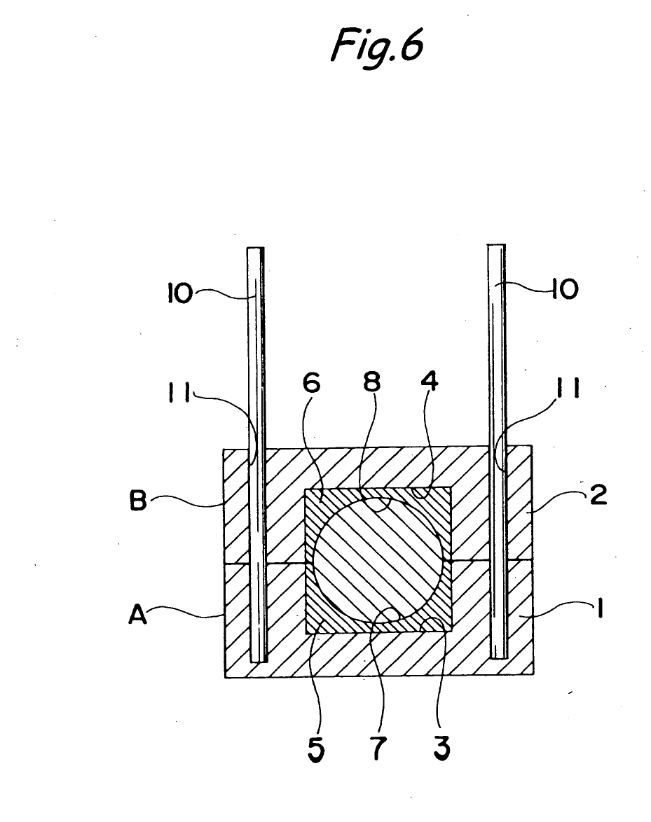

FIGS. 4 to 6 show together the second embodiment of the ice cake maker according to the present invention. In this ice cake maker, the molds A and B include mold bodies 1 and 2, respectively, in pair, formed from a material having a high heat conductivity such as aluminum and having receiving concavities 3 and 4 formed respectively at the sides thereof opposite to each other, and molding blocks 5 and 6, respectively, in pair, formed from a material having a high heat conductivity such as aluminum and having the molding concavities 7 and 8 formed respectively therein and which are to be received replaceably in the receiving concavities 3 and 4.

As above, the molding blocks 5 and 6 having the molding concavities 7 and 8 formed respectively therein are replaceably received in the receiving concavities 3 and 4 respectively. By preparing and selectively using multiple types of molding blocks 5 and 6 different in shape of the molding concavities 7 and 8 from one to another, it is possible to easily make ice cakes of different shapes defined by the molding concavities 7 and 8.

In the molds A and B, The mold bodies 1 and 2, and molding blocks 5 and 6, are formed from a material having a relatively high heat conductivity, selected from among aluminum, copper and the like or their alloys, ceramic and the like. Thus, heat is efficiently conducted through them to the ice lump.

The above material should preferably be a one in which the heat at other parts of the molding blocks 5 and 6 than the molding concavities 7 and 8, where the temperature is higher than that of the molding blocks 5 and 6 near the moving concavities 7 and 8, respectively, where a blank ice lump is cooled while being melted, will rapidly be conducted to the molding blocks 5 and 6 which will thus be prevented from rapidly losing the temperature to melt the ice lump continuously and rapidly along the molding concavities 7 and 8.

Also, each of the molds A and B (including the mold bodies 1 and 2 and molding blocks 5 and 6) is designed to keep such a volume (heat quantity) as will not be at the same temperature (0° C.) as the blank ice lump at least before the ice lump is completely molded by the molding concavities 7 and 8.

In addition, the lower one (A) of the molds A and B (mold body 1) is shaped for stable seating when positioned in place, namely, it is designed to have such a short, generally cylindrical shape, for example, as to be stably stationary during making of ice cakes. The upper one (B) of the molds A and B (mold body 2) is shaped correspondingly to the upper mold A (mold body 1) and for a sophisticated appearance.

Each of the three guide rods 10 is formed from a thin rod of a metal (or synthetic resin). The three guide rods 10 are mounted at the lower end thereof on the lower mold A (mold body 1) to enclose the molding concavity 7, and penetrated through three guide holes 11, respectively, formed in the upper mold B (mold body 2). The upper mold B is slidable on these guide rods 10.

That is, the other (upper) mold B (mold body 2) is smoothly movable toward or away from the one (lower) mold A (mold body 1), and the molds A and B are put into close and accurate contact with each other at the opposite surfaces thereof until there remains no gap between them.

Note that the construction, shape, dimensions, material and quantity, positions, etc. of the guide rods 10 are not limited those illustrated and described herein but they may be designed so simple that they can stably guide the pair of molds A and B (mold bodies 1 and 2) being moved toward or away from each other.

Also, the molds A and B (mold bodies 1 and 2) may be designed to be laid horizontally as well as vertically as illustrated and described herein, and they may be moved toward or away from each other by a hydraulic means, pneumatic means (air cylinder), spring or the like (not illustrated).

The molds A and B (mold bodies 1 and 2) may be designed so that when the molds A and B (mold bodies 1 and 2) are moved away from each other after an ice cake is molded with the opposite surfaces of the pair of molds A and B (mold bodies 1 and 2) being put in close contact with each other, the ice cake will automatically fall down from the molding concavities 7 and 8 and easily be taken out from the ice cake maker.

Note that the above construction of the ice cake maker is more advantageous in case multiple concavities 7 and 8 are formed in each of the molds A and B (mold bodies 1 and 2) to make many ice cakes at the same time.

The receiving concavities 3 and 4 formed in the mold bodies 1 and 2, respectively, have the general shape of a rectangular parallelepiped. They are provided nearly in the center of the opposite sides of the mold bodies 1 and 2. The molding blocks 5 and 6 are designed to have the general shape of a rectangular parallelepiped correspondingly to the shapes of the receiving concavities 3 and 4, respectively. Thus, the molding blocks 5 and 6 are closely fitted removably in the receiving concavities 3 and 4, respectively, and they are smoothly replaceable with molding blocks of any other type, respectively.

Note that the molding blocks 5 and 6 may be fitted in the receiving concavities 3 and 4, respectively, and secured to the mold bodies 1 and 2, respectively, each with a set screw or the like (not illustrated) against easy come-off under any sudden external force applied.

Furthermore, by forming a plurality of receiving concavities 3 and 4 in the mold body 1, it is possible to make many of multiple types of ice cakes at the same time.

The molding concavities 7 and 8 may be formed to have the hemispheric shape as illustrated but also may be formed to have a desired character shape, a mock-natural object shape, a geometric shape or the like. Also, by forming a plurality of molding concavities 7 and 8, it is possible to make a plurality of ice cakes at the same time.

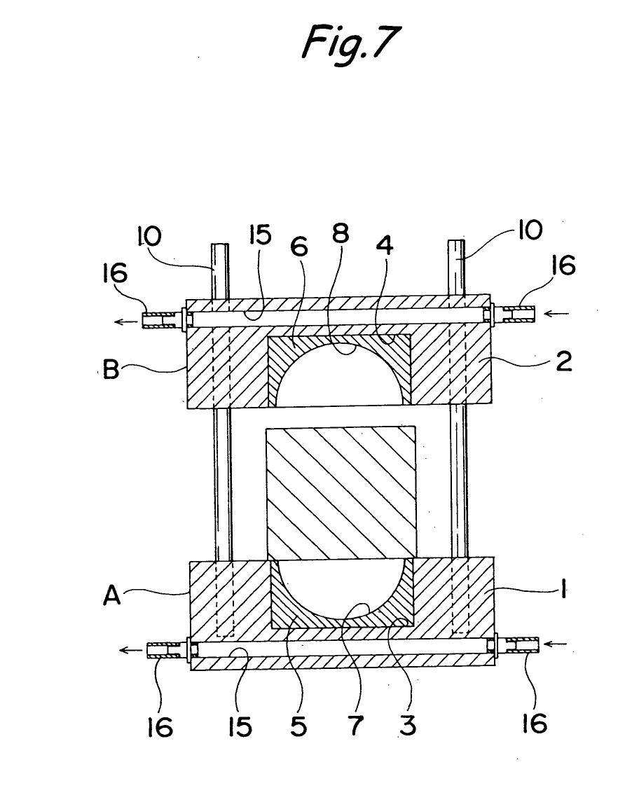

FIG. 7 is a schematic axial sectional view of the third embodiment of the ice cake maker according to the present invention. As shown, the ice cake maker has provided in each of the molds A and B (mold bodies 1 and 2) a water channel 15 supplied with water (tap water) through hoses 16. The water flowing through the water channel 15 easily restores the chilled molds A and B to water temperature (normal temperature) and thus can easily maintain a temperature difference between the ice lump and modes A and B (mold bodies 1 and 2). It should be noted that hot water from a water heater can be used, in place of hold water, to restore the chilled molds A and B to the water temperature more easily and rapidly.

That is, the third embodiment of the ice cake maker is designed with consideration given to continuous making of ice cakes as well as to an improved efficiency of ice cake making. Especially, since the ice cake maker is easily usable with tap water or the like, ice cakes can be made continuously and with a high efficiency.

Note that the water channel 15 is sufficient for the above intention if it is capable of efficient restoration of the chilled molds A and B (mold bodies 1 and 2) to water temperature (normal temperature). The water channel 15 may be laid linearly, in a curve (circularly or spirally) or in any other appropriate form, and the location and number of the water channels 15 is not limited to those illustrated.

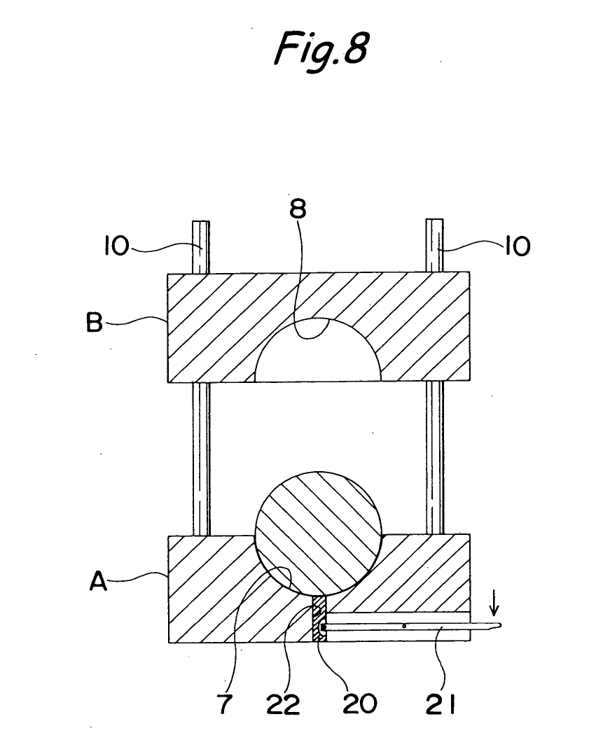

FIG. 8 shows the fourth embodiment of the ice cake maker according to the present invention. As shown, this ice cake maker has an appropriate removing means provided in one (A) of the molds A and B (mold bodies 1 and 2). The removing means is designed to easily take out an ice cake from inside the molding concavity 7 in the mold A without any impairment to it. More specifically, a guide hole 28 is formed in the mold A (mold body 1) to communicate with the molding concavity 7. A push-up rod 20 is slidably provided in the guide hole 28. A lever 21 is connected at the inner end thereof to the push-up rod 20. The lever 21 is secured to the mold A (mold body 1) so that it can be oscillated. By pressing the lever 21 at the free end thereof by the finger, the top end of the push-up rod 20 emerges into the molding concavity 7 and pushes up the molded ice cake there. Thus, the ice cake can easily be removed from inside the molding concavity 7.

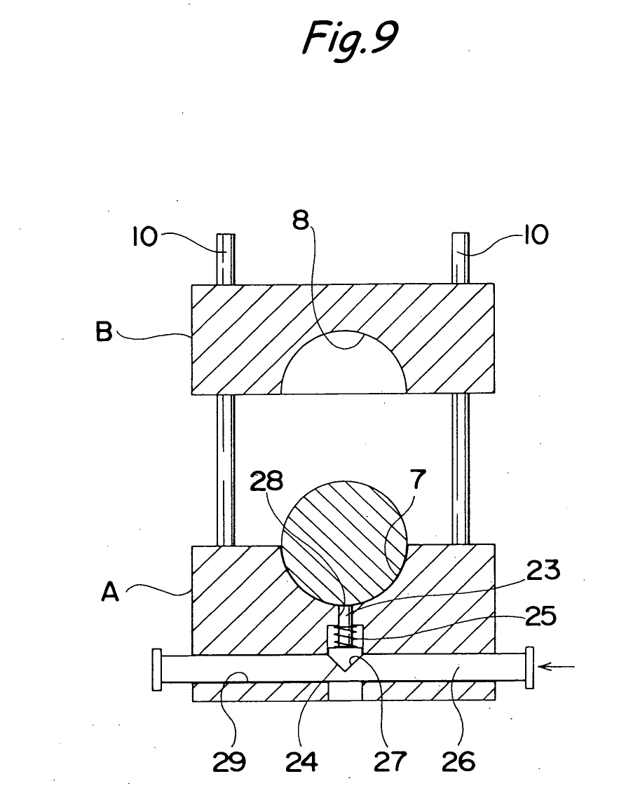

FIG. 9 shows the fifth embodiment of the ice cake maker according to the present invention. As shown, this ice cake maker has provided in one (A) of the molds A and B an appropriate removing means different from that provided in the above-mentioned fourth embodiment. A guide hole 22 is formed in the mold A (mold body 1) to communicate with the molding concavity 7. A push-up rod 23 is slidably provided in the guide hole 22. A spring 25 is provided on the push-up rod 23 inside the guide hole 22 to always force the push-up rod 23. A hole 29 is horizontally penetrated through the lower mold A (mold body 1), and has a operating shaft 26 slidably provided through it. The push-up rod 23 has provided at the lower end thereof a V-shaped projection which is received in a V-shaped recess formed in the operating shaft 26. When the operating shaft 26 is slid horizontally in a direction, the slant face of the V-shaped recess 27 pushes up the corresponding slant face of the V-shaped projection 24 against the force of the spring 25. Thus, the top end of the push-up rod 23 emerges into the molding concavity 7 and pushes up the molded ice cake there. Thus, the ice cake can easily be removed from inside the molding concavity 7.

Note that the construction, shape, dimensions, material and quantity, positions, etc. of each component of the aforementioned embodiments of the ice cake maker according to the present invention are not limited those illustrated and described herein but they may freely be modified from the scope and spirit thereof defined in the claims given later.

In the aforementioned embodiments of the present invention, each of the molds A and B in pair may have formed therein a small drain hole of an appropriate size to smoothly discharge water resulted from melting of a blank ice lump from the molding concavities 7 and 8 to outside the molds A and B.

Next, the ice cake maker having been illustrated and explained is used to make an ice cake as will be described below.

First, the ice cake maker is placed on a horizontal flat surface, and then the upper mold B is lifted upward along the guide rods 10 with the lower mold A being kept stationary. At this time, the molds A and B are at the normal temperature or a lower temperature.

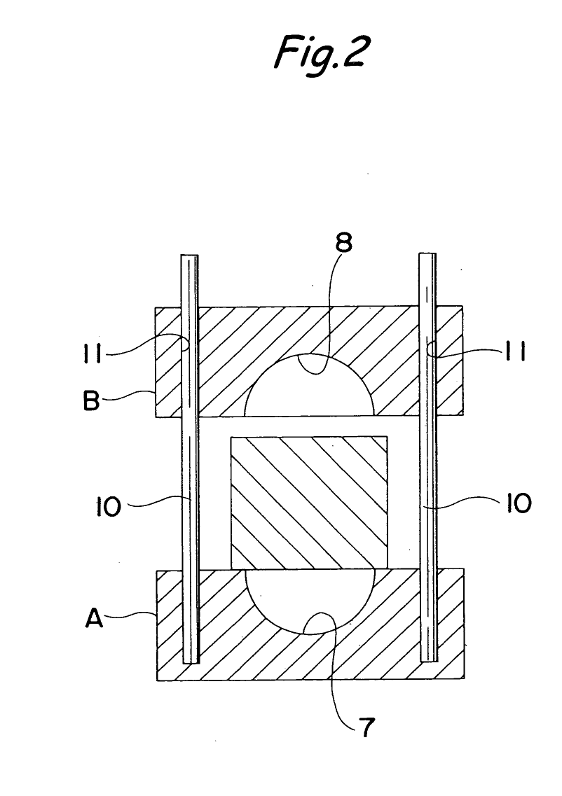

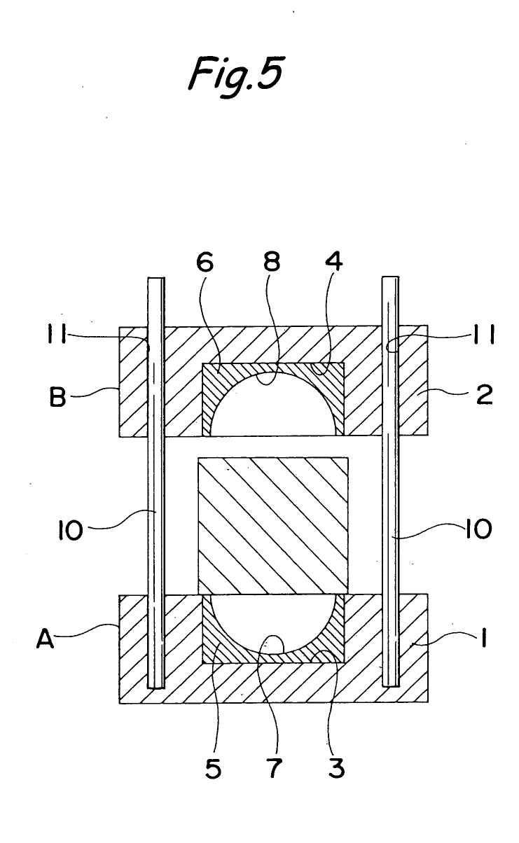

Then, a blank lump having been pre-shaped to a size larger than a predetermined one is placed near the molding concavity 7 in the mold A (as shown in FIGS. 2 and 5). To prevent easy displacement, the ice lump is partially received in the molding concavity 7 or inside a step formed along the opening edge of the molding concavity 7 (not shown).

Note that the blank ice lump may be a block of an appropriate size prepared by cutting a relatively large, clear ice cube made at the ice plant or the like, one, having the appropriate size, of ice pieces made breaking such an ice cube, an ice lump produced in advance to have the appropriate size or a one formed by any other means.

Next, the upper mold B is lowered along the guide rods 10 toward the lower mold A. The mold B is lowered by the its own weight, but it may be lowered by a hydraulic means or spring, for example.

Then, the blank ice lump is pressed between the molds A and B, and a part thereof in contact with the molds A and B is gradually melted owing to a temperature difference between the ice lump and molds A and B until it is shaped as defined by the molding concavities 7 and 8. Thus, an ice cake having the predetermined shape is molded, and then the mold B (mold body 2) is lifted up. The ice cake is then taken output from inside the molding concavity 7 by operating the removing means.

Note that the pair of molds A and B may be designed to pass water inside or outside the molds A and B during or before molding of an ice cake to maintain the temperature difference between a blank ice lump and molds A and B within a predetermined range.

More specifically, the molds A and B may be designed for the water passage to restore the chilled molds A and B to water temperature (normal temperature) so that ice cakes can successively be molded while maintaining the molding capability and efficiency. In addition, for more rapid and easier restoration of the chilled molds A and B to the water or normal temperature, hot water from a water heater may also be used directly or indirectly in place of water.

The ice cake made using the ice cake maker according to the present invention is used for preparation of “on the rock” of an alcoholic beverage, icing of a drink, preservation of the freshness of a food or for other various purposes.

### WORKING EXAMPLES

### Example 1

The aforementioned first embodiment of the ice cake maker according to the present invention was used to make a ball-shaped ice cake of about 60 mm in diameter from a blank ice lump of about 65 mm in diameter (about 230 g) at an ambient temperature of 20° C.

Each of the molds A and B used in this experiment was formed from an aluminum cylinder of 130 mm in diameter and 90 mm in height and weighed about 5.5 kg (including the weight of other stainless steel and plastic parts).

Under the above conditions, the ball-shaped ice cake of about 60 mm in diameter could be made in a time of about 100 seconds, and the temperature of the molds A and B was about 8° C.

### Example 2

A ball-shaped ice cake of about 60 mm was made under the same conditions as in the Example 1 provided that the molds A and B ware pre-heated by hot water to 30° C.

Under the above conditions, the ball-shaped ice cake of about 60 mm could be made in a time of about 40 seconds, and the temperature of the molds A and B was about 18° C.

### Industrial Applicability

As having been described in the foregoing, an ice cake having a predetermined shape can be made easily and rapidly from broken ice pieces or ice lump using the ice cake maker according to the present invention. Any unexperienced one can easily make the ice cakes of a predetermined shape using the ice cake maker.

Further, different from the conventional ice cake makers, no heaters are required in the ice cake maker according to the present invention. Therefore, the ice cake maker according to the present invention can be used safely. Further, it is simply constructed and thus suitable for mass production. Ice cakes or balls can be made inexpensively.

1. An ice cake maker comprising:
a pair of molds formed from a material having a relatively high heat conductivity; and
guide rods which guide the pair of molds being moved relatively in a predetermined direction,
the molds in pair having molding concavities, respectively, formed at the sides thereof opposite to each other; and
a blank ice lump in contact with the molding concavities in the molds in pair being partially melted owing to a temperature difference between itself and molds to form an ice cake having a shape defined by the concavities in the pair of molds.

2. The apparatus as set forth in claim 1, wherein each of the molds is composed of a body having a receiving concavity formed therein and a molding block formed for replaceable installation in the receiving concavity, the molding block having a molding concavity formed therein.

3. The apparatus as set forth in claim 1, wherein each of the molds has formed therein a water channel through which cold or hot water is passed.

4. The apparatus as set forth in claim 1, wherein a removing means is provided in one of the molds to take out a molded ice cake from inside the molding concavity.

5. An ice cake making method comprising the steps of:
disposing, in a lower position, one of a pair of molds formed from a material having a relatively high heat conductivity;
placing a blank ice lump having a predetermined size over a molding concavity formed in the one mold;
lowering the other mold having a molding concavity formed therein along guide rods and toward the one mold in the lower position until the blank ice lump is held tight in contact with the walls of the molding concavities in the molds in pair; and
gradually melting the blank ice lump at its part being in contact with the molds owing to a temperature difference between the blank ice lump and molds until the blank ice lump is formed to have a shaped defined by the pair of molding concavities, to thereby make an ice cake having a predetermined shape.

6. The method as set forth in claim 5, wherein passing cold or hot water inside or outside the molds in pair permits to maintain the temperature difference between the blank ice lump and molds.

7. The apparatus as set forth in claim 2, wherein each of the molds has formed therein a water channel through which cold or hot water is passed.

8. The apparatus as set forth in claim 2, wherein a removing means is provided in one of the molds to take out a molded ice cake from inside the molding concavity.

9. The apparatus as set forth in claim 3, wherein a removing means is provided in one of the molds to take out a molded ice cake from inside the molding concavity.

10. The apparatus as set forth in claim 7, wherein a removing means is provided in one of the molds to take out a molded ice cake from inside the molding concavity.
